(19) United States
(12) Patent Application Publication
(10) Pub. No.: US 2025/0361755 A1
(43) Pub. Date: Nov. 27, 2025

(54) Slip Hinge And Hinge System And Method

(71) Applicant: Meshtec International Co., Ltd., Chiang Mai (TH)

(72) Inventors: David Neil Edlin, Chiang Mai (TH); Peter Syme Taylor, New Farm (AU)

(21) Appl. No.: 19/220,535

(22) Filed: May 28, 2025

Related U.S. Application Data
(60) Provisional application No. 63/651,674, filed on May 24, 2024.

(51) Int. Cl. E05D 11/00; E05D 3/02; E05D 5/06

(52) U.S. Cl. CPC E05D 11/0018; E05D 3/02; E05D 5/06

(57) ABSTRACT

There is provided a hinge system and/or a slip hinge. The system may include a door or window having a sash and a slip hinge. The slip hinge may include: a pin; a base member including a first mounting plate and a first hinge portion, the first mounting plate engaging a frame defining an opening receiving the door or window, and the first hinge portion having a first recess to receive the pin; and a rotating member including a second mounting plate and a second hinge portion, the second mounting plate engaging the sash and the second hinge portion having a second recess to receive the pin; wherein a cross-section of at least one of the first and second hinge portions is substantially polygonal in shape with at least two sides that are not parallel to one another. There is also provided a method of installing a slip hinge.

### CROSS-REFERENCE TO RELATED APPLICATION(S)

This application claims the benefit of and priority to U.S. Application No. 63/654,674, filed May 31, 2024, which is incorporated by reference herein in its entirety.

### FIELD

The present application relates to slip hinges, and more particularly, to slip hinges used in hinge systems.

### BACKGROUND

Security screen systems are available for doors and windows. These systems generally involve securing a mesh, or other infill material, within a frame. Certain of these systems use hinges to allow the doors or windows to swing outwardly or inwardly. An issue with hinges with security screens is that they may tend to deteriorate over time through the course of normal use, i.e., the hinges often become bent or broken. Also, they may be subject to vandalism or deliberate breakage. Individuals may use certain hand tools, such as vice grips, wrenches, pliers, etc., to manipulate and damage the hinges to gain access to a dwelling or building.

Security screen doors or windows may be composed of a strong protective mesh. In one form, the security screen system may be in the form of a security door with tough, resistant mesh. The security door may open outwardly, and a vulnerable point may be the hinges. For example, conventional barrel-shaped hinges may be subject to manipulation and damage. In other words, the hinges may be breakable, such as via a hand tool, allowing access to a third party.

Accordingly, there is a need for a hinge that is robust and capable of repeated use. It also would be desirable to develop a hinge for a security screen system that is more resistant to manipulation and damage. In other words, it would be desirable to develop a hinge for a security screen system that is more resistant to damage by gripping tools. It would be desirable to provide a hinge for a security screen system that provides additional security to prevent undesired access to dwellings or buildings by third parties.

### BRIEF DESCRIPTION OF THE DRAWINGS

FIG. 1 shows a screen system including a mesh and a sash;

FIG. 2 shows a side view of a slip hinge in accordance with certain embodiments;

FIG. 3 shows a top view of the slip hinge of FIG. 2;

FIG. 4 shows a front view of the slip hinge of FIG. 2;

FIG. 5 shows a perspective view of the slip hinge of FIG. 2;

FIG. 6 shows a partially transparent view of the slip hinge of FIG. 2 in an unassembled form;

FIG. 7 shows a perspective view of the slip hinge of FIG. 2 attached to a frame and a sash in a first position;

FIG. 8 shows a top view of the slip hinge of FIG. 7 attached to a frame and a sash;

FIG. 9 shows a perspective view of the slip hinge of FIG. 2 attached to a frame and a sash in a second position;

FIG. 10 shows a perspective view of the slip hinge of FIG. 2 attached to a frame and a sash in a third position;

FIG. 11 shows a top view of the slip hinge of FIG. 9 attached to a frame and a sash;

FIG. 12 shows an exploded perspective view of a slip hinge in an unassembled form; and

FIG. 13 shows a perspective view of the slip hinge of FIG. 12 in an assembled form.

### DETAILED DESCRIPTION

This disclosure has application to a security screen system for doors and windows of buildings, including domestic residences. For illustrative purposes, reference may be made to such applications. However, it is to be understood that this disclosure also has other applications where a mesh screen or interface is desirable. Further, it is also contemplated that the slip hinges described herein may be used with other types of doors, windows, and other applications that do not utilize a mesh screen or interface at all.

The following description is not to be taken in a limiting sense but is made merely for the purpose of describing the general principles of exemplary embodiments. Reference throughout this specification to “one form,” “one embodiment,” “an embodiment,” “some embodiments”, “an implementation”, “some implementations”, “some applications”, or similar language means that a particular feature, structure, or characteristic described in connection with the embodiment is included in at least one embodiment of the present disclosure. Thus, appearances of the phrases “in one embodiment,” “in an embodiment,” “in some embodiments”, “in some implementations”, and similar language throughout this specification do not all refer to the same embodiment.

The terms “top” and “bottom,” “upper” and “lower” and “vertical” and “horizontal as may be used herein are by way of example and illustrative purposes only and are not meant to limit the description of the embodiments inasmuch as the referenced item can be exchanged in position and orientation. Also, as used herein, the terms “substantially” and/or “about” mean that the specified dimension or parameter may be varied within an acceptable manufacturing tolerance for a given application. Further, the terms “substantially” and/or “about” when used to describe a shape means that the shape is identifiable even if certain elements and aspects of the shape have been modified from an exact geometric representation of that shape.

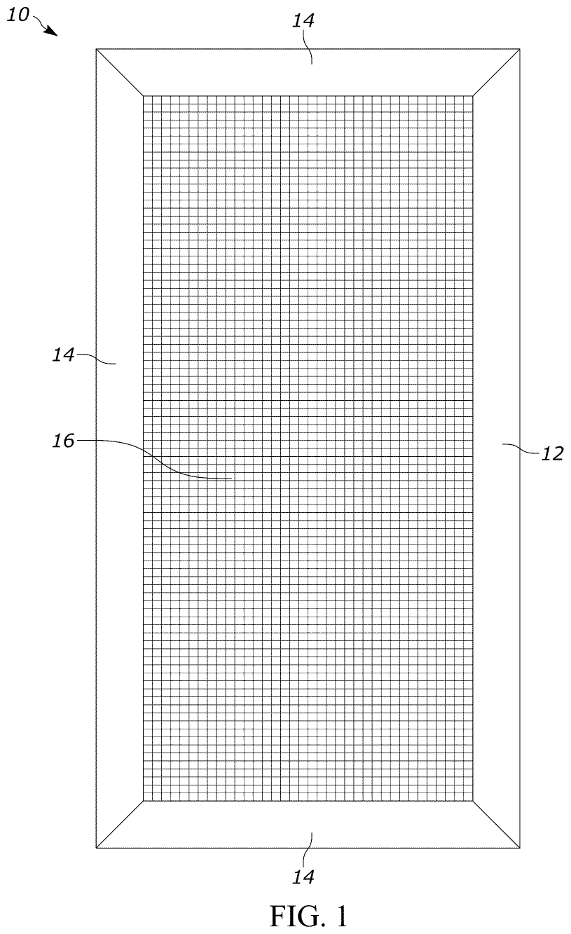

FIG. 1 shows a security screen 10 that includes a rectangular frame 12 (or sash), such as may be formed by four legs 14. The frame 12 defines an opening that is occupied by a mesh/infill screen 16. The sash 12 extends about and supports the mesh/infill screen 16. The material of the mesh/infill screen 16 may be any of various types of infill materials, such as, for example, stainless steel wire, a perforated metal sheet, insect resistant fabric, etc. The sash 12 typically includes aluminum channels with a variety of internal structures for holding the mesh 16, although other materials may also be used for the sash 12. In addition, it should be understood that the terms “mesh” and “infill” are used broadly in this disclosure. The term “infill” is intended broadly to refer to any sort of sheet-like or other material that can be used within a sash 12.

The security screen 10 is just one type of screen that may be used in this disclosure. Security screens may be used for doors, windows, and other bodies that occupy openings, such as in a building or dwelling. Further, the security screen may constitute only a portion of the door or window, for example, while the remaining portion may be composed of a standard material for door or window. It is generally contemplated that the door, window, etc., opens inwardly or outwardly via slip hinges. In some forms, the door, window, etc., need not utilize a mesh or other infill material at all.

At a high level, this disclosure generally involves slip hinges for use with doors and windows. These hinges allow doors and windows to rotate or pivot inwardly and outwardly between open and closed positions. For example, these hinges may be used with an outer security door that opens outwardly. The doors and windows may be configured to be locked or latched in the closed position. In one aspect, this disclosure addresses an issue involving deliberate breakage of hinges by third parties. It has been found that third parties may use certain hand tools, such as vice grips, wrench, pliers, etc., to grip and break the hinges to gain access to a dwelling or building. In other words, in one form, the slip hinges in this disclosure are anti-vice grip hinge designs to prevent a door or window hinge from being forced or broken.

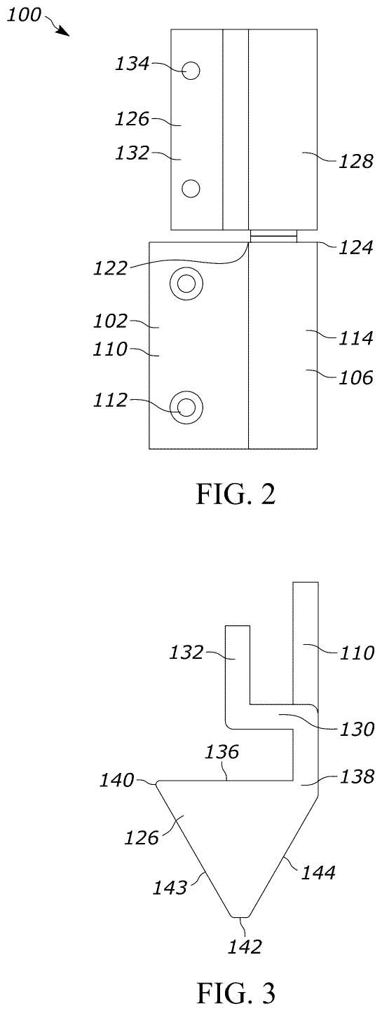

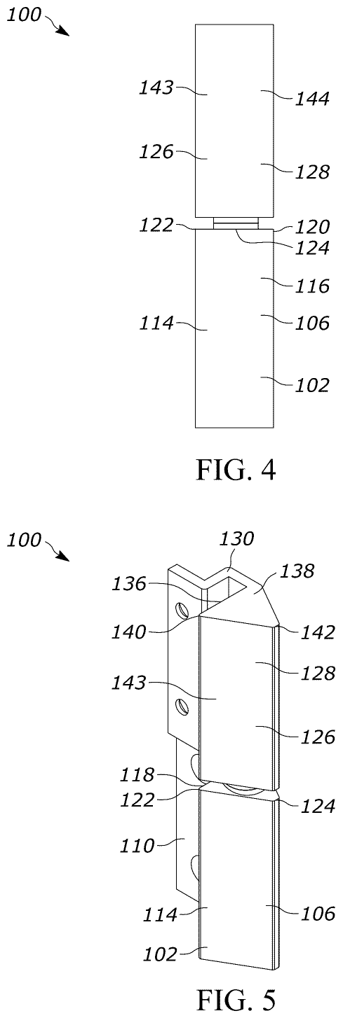

FIGS. 2-6 show an embodiment of a slip hinge 100. It is generally contemplated that the arrangement of the slip hinge 100 in these figures would correspond to a closed position. The slip hinge 100 includes a base (or bottom) member 102 with a pin 104 that extends upwardly from the base member 102. The base member 102 includes a base (or first) hinge portion 106 with a recess therein for holding the pin 104 and a mounting plate 110. As shown in FIG. 2, the mounting plate 110 includes one or more through holes 112, preferably two through holes, for receiving fasteners. The fasteners and mounting plate 110 are affixed to a frame, such as a door frame or window frame, to attach the base member 102 to the frame.

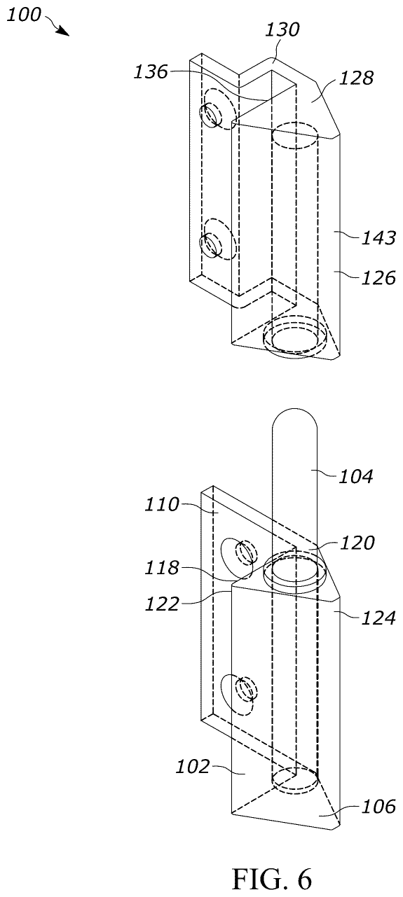

As shown in FIGS. 5 and 6, in this form, the base hinge portion 106 may be in the general shape of a polygon, rather than being barrel-shaped. In other words, the cross-section may be substantially polygonal in shape with at least two sides that are not parallel to one another. As described below, this polygonal shape with non-parallel sides may make gripping of the hinge 100 difficult.

For example, the base hinge portion 106 is preferably substantially triangular in cross-section. It has been found that this triangular cross-section, when oriented properly, helps prevent vice grips or other hand tools from getting a grip on the base member 102. Instead, if the triangular shape is oriented properly, the vice grips or other hand tool tends to slip along the exposed sides 114 and 116 of the triangle. In other words, the vice grips with two opposed jaws cannot get sufficient purchase along the exposed sides 114 and 116 of the base hinge portion 106.

In this regard, the base hinge portion 106 is oriented in a certain manner when the door or window is in a closed position. In this form, the base 118 of the triangle is preferably perpendicular to the mounting plate 110 and intersects the mounting plate 110 at a vertex 120 of the triangle. In this orientation, when the door or window is in a closed position, the vertices 120 and 122 of the base 118 of the triangle are not exposed. In other words, in the closed position, they are not accessible to, and cannot be gripped by, a vice grips or similar hand tool. In this form, only the third vertex 124 that is opposite the base 118 is exposed, and the vice grips or similar hand tool will tend to slide along the exposed sides 114 and 116 of the base hinge portion 106.

It should be understood that other cross-sectional shapes for the base hinge portion 106 may also be used. In some forms, the cross-section of the base hinge portion 106 need only be substantially triangular and may have one or more flattened vertices. In another form, it is contemplated that the cross-sectional shape may be trapezoidal. The cross-sectional shape should generally be selected so that vice grips, or other hand tools with opposing jaws, does not sufficiently grip and/or close properly to allow the exertion of breaking force against the base hinge portion 106.

The slip hinge 100 also includes a rotating (or top) member 126 that is inserted onto the pin 104. The rotating member 126 preferably includes a second hinge portion 128 with a recess therein that is sized for receiving the pin 104, a connecting portion 130, and a mounting plate 132. As shown in FIG. 2, the mounting plate 132 includes one or more through holes 134, preferably two through holes, for receiving fasteners. In some forms, the fasteners and mounting plate 132 are preferably affixed to a sash, such as the sash of a security screen door or window, to attach the rotating member 126 to the sash. In other forms, the fasteners and mounting plate 132 are affixed to an edge of another type of door or window to attach the rotating member 126 to the edge of that door or window.

In this form, the connecting portion 130 connects the second hinge portion 128 to the mounting plate 132. As shown in FIGS. 3 and 6, in this form, the connecting portion 130 is generally L-shaped such that the mounting plates 110 and 132 are generally parallel. In other words, the mounting plate 132 of the rotating member 126 may generally be parallel to the mounting plate 110 of the base member 102 in a closed position. In other forms, the mounting plates 110 and 132 need not be parallel, depending on the positions of the frame and the sash/edge of door/window. The positional relationship of the connecting portion 130 to the mounting plate 132 may help establish the orientation of the second hinge portion 128. In other forms, the connecting portion 130 may be some other desired shape so as to position and orient the second hinge portion 128. As addressed further below, the second hinge portion 128 may have a desired orientation when the door or window is in a closed position.

As shown in FIGS. 5 and 6, in this form, the second hinge portion 128 is also preferably substantially polygonal in cross-section, rather than being barrel-shaped or generally circular in cross-section. In one form it is preferably substantially triangular in cross-section (like base hinge portion 106). This cross-sectional shape is preferred for the same reason, i.e., it helps prevent vice grips or other hand tools from getting a grip on the second hinge portion 128. Further, as addressed below, it is generally contemplated that the two hinge portions 106 and 128 preferably have the same orientation with respect to one another when the door or window is in the closed position, i.e., they are preferably aligned with one another.

In this form, the base 136 of the triangle is preferably perpendicular to the mounting plate 132 (when the plane defined by the mounting plate 132 is extended). The base 136 is also perpendicular to one side of the connecting portion 130, and it intersects this part of the connecting portion 130 at a vertex 138 of the triangle. In this orientation, when the door or window is in a closed position, the vertices 138 and 140 of the base 136 of the triangle are not exposed. In other words, in the closed position, they are not accessible to, and cannot be gripped by, a vice grips or similar hand tool. In this form, only the third vertex 142 that is opposite the base 136 is exposed, and the vice grips or similar hand tool will tend to slide along the exposed sides 143 and 144 of the second hinge portion 128. In one form, the substantially triangular cross-sections of the hinge portions 106 and 128 may define equilateral triangles.

As with the base member 102 addressed above, it should be understood that other cross-sectional shapes for the second hinge portion 128 may also be used. In some forms, the cross-section of the second hinge portion 128 need only be substantially triangular and may have one or more flattened vertices. In another form, it is contemplated that the cross-sectional shape may be trapezoidal. The cross-sectional shape should generally be selected so that vice grips, or other hand tools with opposing jaws, does not sufficiently grip and/or close properly to allow the exertion of breaking force against the second hinge portion 128. In some forms, the two hinge portions 106 and 128 may have different cross-sectional shapes.

It is generally contemplated that the pin 104 is fixed relative to the base member 102. In other words, in one form, the pin 104 is fixed against rotation relative to the base hinge portion 106. In contrast, the rotating member 126 may be mounted onto or lifted off the pin 104. Further, it is generally contemplated that the rotating member 126 is free to rotate or pivot when mounted onto the pin 104. The slip hinge 100 may allow a door or window to be readily removed when the door or window is in an open position because the door or window can be lifted off the pin 104. However, it prevents the door or window from being removed when the door or window is in a closed position.

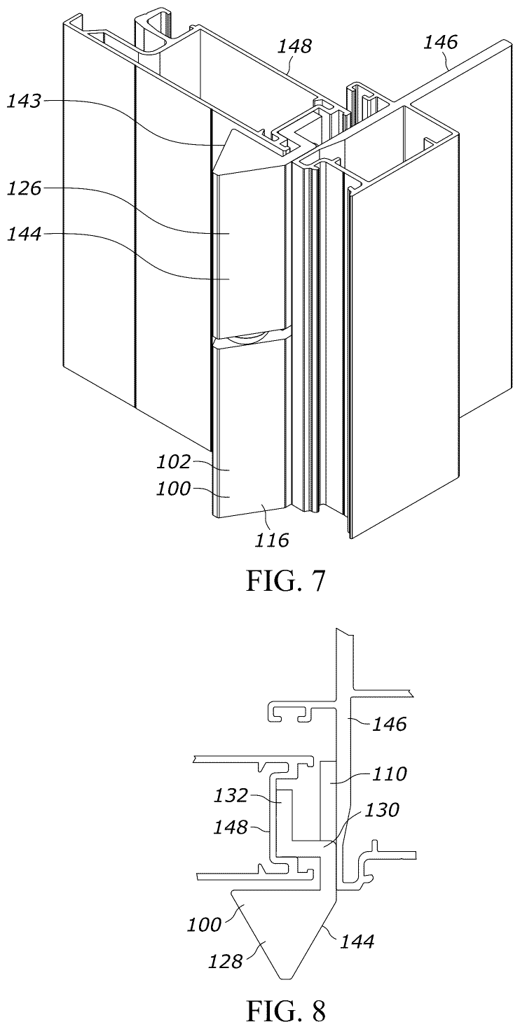

FIGS. 7-11 show slip hinge 100 attached to a frame and a sash and in several different positions. It is generally contemplated that the sash constitutes the outer part of a door or window, such as a security screen door or window. In other forms, the slip hinge 100 may be attached to an edge of another type of door or window, not a security screen door or window having a sash. Further, it is generally contemplated that the frame constitutes a door frame or window frame.

FIG. 7 shows the slip hinge 100 in a rest position, and in this position, the door or window is closed. As can be seen, the base (or bottom) member 102 is disposed next to but beneath the rotating (or top) member 126. The pin 104 interconnects the two members 102 and 126. The spacing between the base member 102 and the rotating member 126 is preferably sufficiently small to prevent access to a hand tool that might be used to break or damage the pin 104.

The mounting plate 110 of the base member 102 is used to mount the base member 102 to the frame 146. In this form, the mounting plate 110 is parallel to and engages the frame 146 such that fasteners can secure the mounting plate 110 to the frame 146. As can be seen, the positional configuration of the mounting plate 110 relative to the base hinge portion 106 is arranged so that, when the mounting plate 110 is secured to the frame 146, the base hinge portion 106 is in the desired orientation. More specifically, the base 118 of the triangular shape is perpendicular to the mounting plate 110 and intersects the mounting plate 110 at a vertex 120 of the triangle.

In this closed position in FIG. 7, the only exposed portion of the base member 102 is the base hinge portion 106. In this orientation, the triangular cross-section of the base hinge portion 106 helps prevent vice grips or other hand tools from getting a grip on the base member 102. Instead, as can be seen, the vice grips or other hand tool will tend to slip along the exposed sides 114 and 116 of the base hinge portion 106. In other words, the hand tool with two opposed jaws cannot lock onto the exposed sides 114 and 116 of the base hinge portion 106.

In this closed position, the base 118 engages and is generally parallel to the sash 148, and the vertices 120 and 122 of the base 118 of the triangle are not exposed. In other words, in the closed position, they are not accessible to, and cannot be gripped by, a vice grips or similar hand tool. In this form, only the third vertex 124 that is opposite the base 118 is exposed, and the vice grips or similar hand tool will tend to slide along the exposed sides 114 and 116 of the base hinge portion 106.

The rotating (or top) member 126 is arranged in a similar manner relative to the sash 148. The mounting plate 132 of the rotating member 126 is used to mount the rotating member 126 to the sash 148. In this form, the connecting portion 130 positions the mounting plate 132 relative to the sash 148. In other forms, the connecting portion 130 may be some other desired shape so as to position and orient the second hinge portion 128. The mounting plate 132 is parallel to and engages an end of the sash 148 such that fasteners can secure the mounting plate 132 to the end of the sash 148. The end of the sash 148 is preferably recessed to facilitate engagement with the mounting plate 132. As can be seen, the positional configuration of the mounting plate 132 relative to the second hinge portion 128 is arranged so that, when the mounting plate 132 is secured to the sash 148, the second hinge portion 128 is in the desired orientation.

Again, in this orientation of the rotating member 126, the triangular cross-section of the second hinge portion 128 helps prevent vice grips or other hand tools from getting a grip on the rotating member 126. Instead, as can be seen, the vice grips or other hand tool will tend to slip along the exposed sides 143 and 144 of the second hinge portion 128. In this orientation, the base 136 engages and is generally parallel to the sash 148, and the vertices 138 and 140 of the base 136 of the triangle are not exposed. In this form, only the third vertex 142 that is opposite the base 118 is exposed, and the vice grips or similar hand tool will tend to slide along the exposed sides 143 and 144 of the second hinge portion 128.

FIG. 8 shows a top view of the slip hinge 100, frame 146, and sash 148 in the closed position. The sizes and dimensions are selected so that the mounting plates 110 and 132 engage the frame 146 and sash 148, respectively, to provide a suitably small sized gap between frame 146 and sash 148. Further, this gap must be sufficiently large to accommodate the thickness of the connecting portion 130 and mounting plate 110.

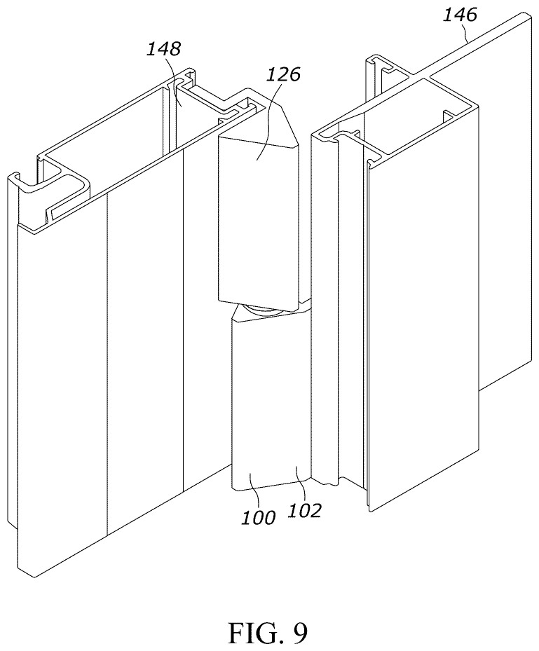

FIG. 9 shows the slip hinge 100 in a 90-degree position relative to its rest position, and in this position, the door or window has been rotated 90 degrees from the closed position to a first open position. The rotating member 126 is free to rotate or pivot on the pin 104. The rotating member 126 has rotated 90 degrees from its original position, while the base member 102 remains stationary. As can be seen, in this position, the sash 148 is generally parallel to the frame 146.

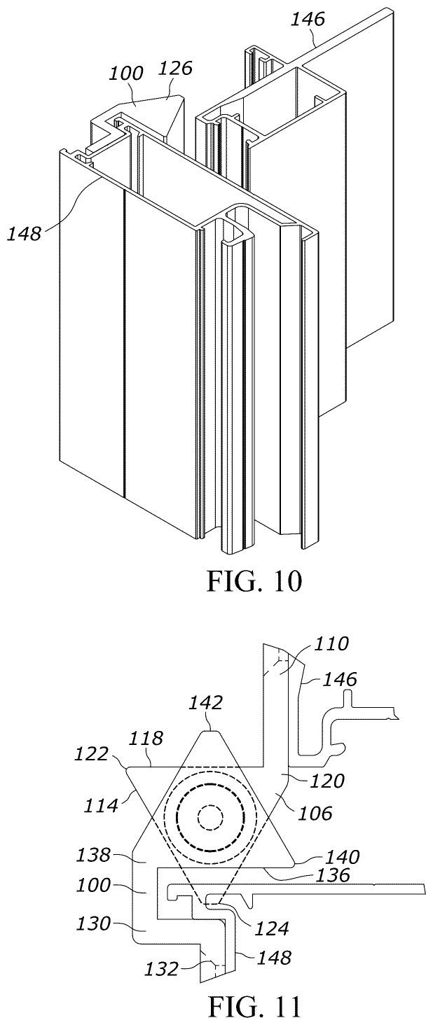

FIG. 10 shows the slip hinge 100 in a 180-degree position relative to its rest position, and in this position, the door or window has been rotated 180 degrees from the closed position to a second open position. The rotating member 126 has rotated 180 degrees from its original position. As can be seen, in this position, the sash 148 is again generally perpendicular to the frame 146.

FIG. 11 shows a top view of the slip hinge 100, frame 146, and sash 148 as the door or window is being moved from the closed position to the open positions. In one form, the vertices 124 and 142 of the two hinge portions 106 and 128 each preferably have a flattened tip so that there is sufficient clearance with the frame 146 and sash 148, as the rotating member 126 rotates. In other words, the vertex 142 should be able to rotate past the frame 146 without hitting it, and similarly, the sash 148 should rotate past the vertex 124 without engaging it.

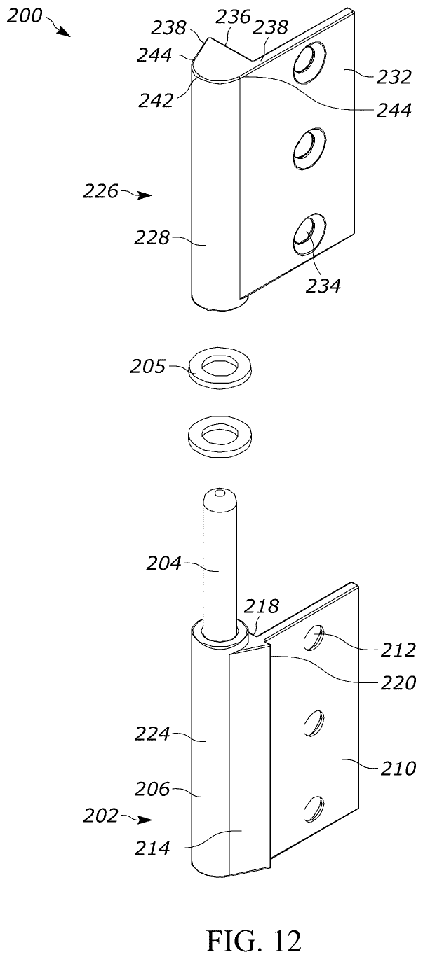

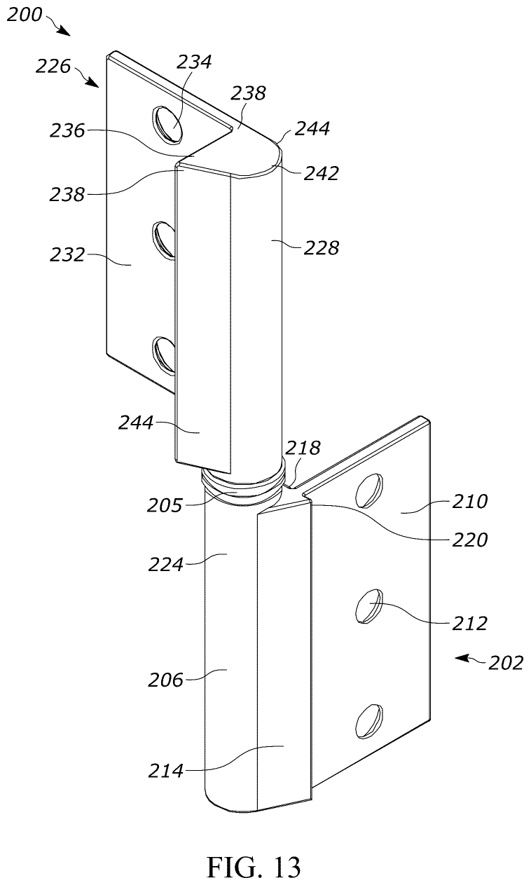

FIGS. 12 and 13 show another form of a slip hinge 200. Again, in one aspect, it is contemplated that the slip hinge 200 is an anti-vice grip hinge design to prevent a door or window hinge from being forced or broken. In one form, slip hinge 200 includes two hinge portions with at least two sides that are not parallel to one another. It is contemplated that this shape with non-parallel sides makes gripping of the hinge 200 difficult and helps prevent vice grips or other hand tools from getting a grip on the hinge portions. The above description is generally incorporated herein, and 200s reference numerals are used that generally correspond with 100s reference numerals, except as indicated below.

As shown in FIGS. 12 and 13, in one form, slip hinge 200 includes a base member 202, a top member 226, a pin 204, and two washers 205. The base member 202 includes a base hinge portion 206 (or first hinge portion) with a recess for holding the pin 204 and includes a mounting plate 210. The mounting plate 210 may include through hole(s) 212 (in this form, three through holes) for receiving fasteners. The fasteners and mounting plate 210 may be affixed to a frame, such as a door frame or window frame, to attach the base member 202 to the frame.

In this form, the base hinge portion 206 is in the general shape of a triangle with a rounded edge 224 replacing a vertex. In other words, the base hinge portion 206 has a base 218 with two sides (or legs) 214 that extend in a direction away from the mounting plate 210, and they are angled so as to intersect with one another, if extended. However, rather than intersecting, the two sides 214 extend into curved portions that form the rounded edge 224. It is contemplated that the benefits of this rounded embodiment are similar to the embodiments described earlier, but the rounding may make it even more difficult for an individual to get purchase on the hinge by tools such as vice grips.

In this form, the base 218 of the triangle is preferably perpendicular to the mounting plate 210 and intersects the mounting plate 210 at or near a vertex 220 of the triangle. In this orientation, when the door or window is in a closed position, the vertices 220 of the base 218 of the triangle are not exposed. In other words, in the closed position, they are generally not accessible to, and cannot be readily gripped by, a vice grips or similar hand tool. In this form, only the rounded edge 224 that is opposite the base 218 is exposed, and the vice grips or similar hand tool will tend to slide along the exposed sides 214 of the base hinge portion 206.

As shown in FIGS. 12 and 13, the slip hinge 200 also includes a rotating (or top) member 226 that is inserted onto the pin 204. The rotating member 226 preferably includes a second hinge portion 228 with a recess for receiving the pin 204 and a mounting plate 232. The mounting plate 232 includes one or more through holes 234 (in this form, three through holes) for receiving fasteners. In some forms, the fasteners and mounting plate 232 are affixed to a sash, such as the sash of a door or window, to attach the rotating member 226 to the sash.

In this form, the second hinge portion 228 may have a shape similar to the first hinge portion 206, rather than being barrel-shaped or generally circular in cross-section. In one form it is preferably substantially triangular in cross-section but with a rounded edge 242 (like base hinge portion 206). This cross-sectional shape is preferred for the same reason, i.e., it helps prevent vice grips or other hand tools from getting a grip on the second hinge portion 228. Further, in one form, it is contemplated that the two hinge portions 206 and 228 may have the same orientation with respect to one another when the door or window is in the closed position, i.e., they may be aligned with one another.

In this form, the base 236 of the triangle is preferably perpendicular to the mounting plate 232. In this form, the base 236 intersects the mounting plate 232 at a vertex 238 of the triangle. In one orientation, when the door or window is in a closed position, the vertices 238 of the base 236 of the triangle are not exposed. In other words, in the closed position, they are not generally accessible to, and cannot be readily gripped by, a vice grips or similar hand tool. In this form, only the rounded edge 242 that is opposite the base 236 is exposed, and the vice grips or similar hand tool will tend to slide along the exposed sides 244 of the second hinge portion 228. In this form, the cross-section of the first and second hinge portions 206 and 228 are substantially triangular but each with a rounded edge. It should be understood that, in other forms, other cross-sectional shapes for the first and second hinge portions 206 and 228 may also be used.

In some forms, it is contemplated that the pin 204 is fixed relative to the base member 202. In other words, in one form, the pin 104 is fixed against rotation relative to the base hinge portion 206. In contrast, the rotating member 226 may be mounted onto or lifted off the pin 204. Further, it is generally contemplated that the rotating member 226 is free to rotate or pivot when mounted onto the pin 204. The slip hinge 200 may allow a door or window to be readily removed when the door or window is in an open position because the door or window can be lifted off the pin 204. However, it prevents the door or window from being removed when the door or window is in a closed position.

As shown in FIGS. 12 and 13, in some forms, the slip hinge 200 may include one or more washers 205 (in this form, two washers). During assembly, the washer(s) 205 are inserted around the pin 204 between the base member 202 and the top member 226. It should be understood that washer(s) may also be used with other embodiments described herein.

Generally speaking, pursuant to various embodiments, systems, apparatuses and methods are provided herein involving a hinge system and/or slip hinge. In one form, a hinge system includes a door or window having a sash and a slip hinge. The slip hinge includes: a pin; a base member including a first mounting plate and a first hinge portion, the first mounting plate configured to engage a frame defining an opening configured to receive the door or window, and the first hinge portion having a first recess to receive the pin therein; and a rotating member including a second mounting plate and a second hinge portion, the second mounting plate configured to engage the sash and the second hinge portion having a second recess to receive the pin therein; wherein a cross-section of at least one of the first and second hinge portions is substantially polygonal in shape with at least two sides that are not parallel to one another.

In some implementations, a cross-section of the at least one of the first and second hinge portions is substantially triangular in shape. In some implementations, the cross-section of the least one of the first and second hinge portions is a triangle having a truncated vertex. In some implementations, the triangle has a base disposed adjacent to and engaging the sash and the truncated vertex is opposite the base. In some implementations, a cross-section of the at least one of the first and second hinge portions is substantially trapezoidal in shape. In some implementations, the cross-section of the least one of the first and second hinge portions is in the shape of a triangle in which a rounded edge replaces a vertex. In some implementations, each of the first and second hinge portions have a cross-section that is substantially triangular in shape. In some implementations, the first hinge portion is connected to the first mounting plate at a vertex of the substantially triangular cross-section. In some implementations, the first and second hinge portions are aligned with one another in a first position in which the door or window is in a closed position. In some implementations, the second hinge portion is configured for rotation about the pin to pivot the door or window to an open position. In some implementations, the first hinge portion is configured not engage sash and the second hinge portion is configured not to engage the frame, upon pivoting the door or window to the open position. In some implementations, the rotating member comprises a connecting portion intermediate the second mounting plate and the second hinge portion, the connecting portion configured to position the second mounting plate into engagement with an end of the sash.

In another form, there is a provided a slip hinge. The slip hinge includes: a pin; a base member including a first mounting plate and a first hinge portion, the first mounting plate configured to engage a frame defining an opening configured to receive a door or window, and the first hinge portion having a first recess to receive the pin therein; a rotating member including a second mounting plate and a second hinge portion, the second mounting plate configured to engage an edge of the door or window and the second hinge portion having a second recess to receive the pin therein; wherein a cross-section of at least one of the first and second hinge portions is substantially polygonal in shape with at least two sides that are not parallel to one another.

In some implementations, a cross-section of the at least one of the first and second hinge portions is substantially triangular in shape. In some implementations, the cross-section of the least one of the first and second hinge portions is a triangle having a truncated vertex. In some implementations, a cross-section of the at least one of the first and second hinge portions is substantially trapezoidal in shape. In some implementations, the cross-section of the least one of the first and second hinge portions is in the shape of a triangle in which a rounded edge replaces a vertex. In some implementations, each of the first and second hinge portions have a cross-section that is substantially triangular in shape. In some implementations, the first and second hinge portions are aligned with one another in a first position in which the door or window is in a closed position. In some implementations, the second hinge portion is configured for rotation about the pin to pivot the door or window to an open position.

In another form, there is provided a method of installing a slip hinge, the method including: fastening a first mounting plate of a slip hinge to a frame defining an opening configured to receive a door or window, the slip hinge comprising a base member including the first mounting plate and a first hinge portion having a first recess with a pin therein; fastening a second mounting plate of the slip hinge to an edge of the door or window, the slip hinge comprising a rotating member including the second mounting plate and a second hinge portion, the second hinge portion having a second recess to receive the pin therein; lowering the second hinge portion onto the pin so that pin is received within the second recess; wherein a cross-section of at least one of the first and second hinge portions is substantially polygonal in shape with at least two sides that are not parallel to one another. In some implementations, a cross-section of the at least one of the first and second hinge portions is substantially triangular in shape.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of the technological contribution. The actual scope of the protection sought is intended to be defined in the following claims.

What is claimed is:

1. A hinge system comprising:
a door or window having a sash; and
a slip hinge comprising:
a pin;
a base member including a first mounting plate and a first hinge portion, the first mounting plate configured to engage a frame defining an opening configured to receive the door or window, and the first hinge portion having a first recess to receive the pin therein; and
a rotating member including a second mounting plate and a second hinge portion, the second mounting plate configured to engage the sash and the second hinge portion having a second recess to receive the pin therein;
wherein a cross-section of at least one of the first and second hinge portions is substantially polygonal in shape with at least two sides that are not parallel to one another.

2. The hinge system of claim 1, wherein a cross-section of the at least one of the first and second hinge portions is substantially triangular in shape.

3. The hinge system of claim 2, wherein the cross-section of the least one of the first and second hinge portions is a triangle having a truncated vertex.

4. The hinge system of claim 3, wherein the triangle has a base disposed adjacent to and engaging the sash and the truncated vertex is opposite the base.

5. The hinge system of claim 2, wherein the cross-section of the least one of the first and second hinge portions is in the shape of a triangle in which a rounded edge replaces a vertex.

6. The hinge system of claim 1, wherein each of the first and second hinge portions have a cross-section that is substantially triangular in shape.

7. The hinge system of claim 6, wherein the first hinge portion is connected to the first mounting plate at a vertex of the substantially triangular cross-section.

8. The hinge system of claim 6, wherein the first and second hinge portions are aligned with one another in a first position in which the door or window is in a closed position.

9. The hinge system of claim 8, wherein the second hinge portion is configured for rotation about the pin to pivot the door or window to an open position.

10. The hinge system of claim 9, wherein the first hinge portion is configured not to engage sash and the second hinge portion is configured not to engage the frame, upon pivoting the door or window to the open position.

11. The hinge system of claim 1, wherein the rotating member comprises a connecting portion intermediate the second mounting plate and the second hinge portion, the connecting portion configured to position the second mounting plate into engagement with an end of the sash.

12. A slip hinge comprising:
a pin;
a base member including a first mounting plate and a first hinge portion, the first mounting plate configured to engage a frame defining an opening configured to receive a door or window, and the first hinge portion having a first recess to receive the pin therein; and
a rotating member including a second mounting plate and a second hinge portion, the second mounting plate configured to engage an edge of the door or window and the second hinge portion having a second recess to receive the pin therein;
wherein a cross-section of at least one of the first and second hinge portions is substantially polygonal in shape with at least two sides that are not parallel to one another.

13. The slip hinge of claim 12, wherein a cross-section of the at least one of the first and second hinge portions is substantially triangular in shape.

14. The slip hinge of claim 13, wherein the cross-section of the least one of the first and second hinge portions is a triangle having a truncated vertex.

15. The slip hinge of claim 13, wherein the cross-section of the least one of the first and second hinge portions is in the shape of a triangle in which a rounded edge replaces a vertex.

16. The slip hinge of claim 12, wherein each of the first and second hinge portions have a cross-section that is substantially triangular in shape.

17. The slip hinge of claim 16, wherein the first and second hinge portions are aligned with one another in a first position in which the door or window is in a closed position.

18. The slip hinge of claim 17, wherein the second hinge portion is configured for rotation about the pin to pivot the door or window to an open position.

19. A method of installing a slip hinge comprising:
fastening a first mounting plate of a slip hinge to a frame defining an opening configured to receive a door or window, the slip hinge comprising a base member including the first mounting plate and a first hinge portion having a first recess with a pin therein;
fastening a second mounting plate of the slip hinge to an edge of the door or window, the slip hinge comprising a rotating member including the second mounting plate and a second hinge portion, the second hinge portion having a second recess to receive the pin therein; and
lowering the second hinge portion onto the pin so that pin is received within the second recess;
wherein a cross-section of at least one of the first and second hinge portions is substantially polygonal in shape with at least two sides that are not parallel to one another.

20. The method of claim 19, wherein a cross-section of the at least one of the first and second hinge portions is substantially triangular in shape.
